(19) United States
(12) Patent Application Publication
(10) Pub. No.: US 2005/0045263 A1
(43) Pub. Date: Mar. 3, 2005

(54) Device for application of labels to containers

(76) Inventors: Bernhard Heuft, Burgbrohl (DE); Hans-Ulrich Goller, Bonn-Bad Godesberg (DE)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(21) Appl. No.: 10/489,950

(22) PCT Filed: Sep. 19, 2002
(86) PCT No.: PCT/EP02/10528

(30) Foreign Application Priority Data
Sep. 19, 2002 (DE) 201-15-480.3

(51) Int. Cl. B65C 9/40; B32B 31/00

(52) U.S. Cl. 156/64; 156/363

(57) ABSTRACT

The apparatus serves to apply a label to a container through the use of an electrooptical device that senses the orientation of the container and sends the signal to a control device that directs the rotation of the containers to a target orientation that allows the label to be applied at a predetermined position on the container. A method for applying a label to a container is also disclosed.

### CROSS-REFERENCE TO RELATED PATENT APPLICATIONS

This patent application is the National Stage of International Application No. PCT/EP02/10528 filed Sep. 19, 2002, which claims priority from German patent application DE 20115 480.3 filed Sep. 19, 2001.

### FIELD OF THE INVENTION

This invention pertains to packaging equipment and, more particularly, to a device and a method for labeling packaging containers.

### BACKGROUND OF THE INVENTION

Labeling machines for containers, in particular bottles, in which the containers are oriented are known from DE-A-41 20 887 and EP-A-0 443 617. To this end, the containers have marks in the form of a notch or recess in the lower area of their vertical wall or on the base. A pawl or spring-loaded orienting element locks into the notch or recess, as a result of which the orientation of the container is fixed.

Apparatuses for orienting rotation-symmetrical bodies, in particular bottles, in labelling machines are also known from DE-A-29 03 470, DE-U-75 12 621, DE-A-199 27 668, EP-A-0 572 758, DE-U-1 949 135 and DE-B-1 200 197, the bottles being rotated by means of the device for rotating the containers and the rotating being stopped once an optical sensor records a mark on the bottle.

Similar apparatuses are known from DE-A-21 26 757 and DE-U-77 09 937, a mechanical scanner or switch being actuated here by the mark on the bottle.

Apparatuses for monitoring the placing of a label on bottles are known from DE-C-40 16 150 and DE-U-295 13 600.

A labelling machine for applying two labels to each bottle is known from U.S. Pat. No. 5,478,422, a sensor measuring the position of the first label at the edge of the revolving platform and the direction of rotation and speed of rotation being calculated such that the second label is applied at a preset position of the same bottle.

So-called champagne orientation is also known. A champagne bottle is passed by a classification worm to an orientation star and rotated by a revolving belt (friction belt). For each bottle position, the orientation star has a bottle rotation device in the form of the friction belt and a close-range scanner. An electromagnetic coupling and a brake are fitted between the belt drive roller and its drive. The coupling and the brake are electronically controlled. During rotation, an optoelectronic close-range scanner scans the periphery of the bottle. A mark on the champagne bottle top is recognized by the close-range scanner which, thereupon releases the coupling and activates the brake. The champagne bottle is fixed in the desired position as a result and passed in the correct position (target orientation) to the bottle table on which the champagne bottles stand while the labels are applied. It is also known to orient the bottles on the revolving platform of the labelling apparatus, to which end the turntables provided in the revolving platform are rotated by means of servomotors.

Another labeling apparatus is disclosed in FR-2 436 725 which is directed to an apparatus where the handle or label is recognized by means of an electrooptical which also ascertains the orientation of the container. Based on this recognition, the bottles are rotated 180°, if necessary.

An apparatus for controlling the rotation movement of vessels and their orientation in a position defined relative to the direction of transport with several motor-driven revolving platforms is proposed in EP-A-1 205 388 (state of the art according to Article 54(3) EPC). The position of the vessels is established by means of scanning devices. The position of the vessels in a position defined relative to the direction of transport is recorded and used in a control device as the shortest rotation of the driven revolving platform with the vessel into its desired handling position, and transmitted to the servomotor as a control signal.

### BRIEF SUMMARY OF THE INVENTION

The object of the invention is to increase the production capacity, i.e. the operating speed, and simultaneously reduce the required space.

This object is achieved according to the invention in that the optoelectronic device records the orientation of the containers and in that a control device controls the device for rotating the containers, depending on the recorded orientation, such that the containers have a desired target orientation in the device for applying the labels.

The invention relates to an apparatus for applying labels to containers, which have a longitudinal axis. The apparatus contains an optoelectronic device for recording the orientation (i.e., rotational alignment) of the containers while also producing a signal which identifies the orientation of the containers, and a device for rotating the containers about their longitudinal axis into a target orientation in which the labels are applied to the containers in a preset position, and a device for applying the labels. The apparatus can have a closure which has a surface directed normally relative to the longitudinal axis with an inscription. In operation, the signals of the electrooptical device are relayed by a control device to the target orientation of the containers and the device for rotating the containers is controlled by the control device such that the containers are in target orientation before the labels are applied.

The optoelectronic-recording device is stationary and a single such device is sufficient to record the orientation of each of the containers, which are conveyed one after the other past the recording device by means of a conveyor.

The time required for orienting the containers is reduced because the orientation of the containers is recorded which means that the required angle of rotation required to reach the target orientation can already be established by means of the control device at the beginning of the rotation. As a result, the control device can also establish whether the target orientation can be reached more quickly by left-or-right-hand rotation of the container. As a result the maximum rotation required is 180°. In contrast, a rotation of almost 360° may be required in individual cases with the apparatuses named at the outset according to the state of the art as the containers are only ever rotated in one direction and further rotation stopped only when the pawl locks into the notch or the optical mark is in front of the close-range scanner.

By halving the maxim angle of rotation required, there is a corresponding reduction of the distance required to rotate the containers at a preset transport speed with the result that the inlet star can be developed correspondingly smaller.

The orientation of the containers can be recorded by means of an optical mark on the containers, for example by means of a mark visible in UV light. In a particularly preferred version, the apparatus according to the invention is provided for containers, which have a closure which has a surface directed normally relative to the longitudinal axis. The orientation of the containers is recorded using an imprint on the closure. This imprint which can contain e.g. the product name or the manufacturer's name, is evaluated by means of known image-processing methods. In the case of drinks bottles which are sealed with crown cap closures or screw closures, or cylindrical cans with an embossing or inscription on the lid, the label can then be oriented according to the lid inscription, which gives the product a more attractive appearance. Several containers or bottles can then also be easily arranged in a sales packaging (beer crate) in the same orientation both of the closures and the labels, which likewise results in an ordered and thus more attractive appearance of the sales packaging.

The mark can also consist of three-dimensional features of the container or bottles, e.g. an engraved label or an embossing of a drink bottle. The orientation of the bottle would be in accordance with this mark with the result that the label points in the same direction as the engraved label or embossing.

A particular advantage of the apparatus according to the invention is that the containers and the closure can be completely rotation-symmetrical as the inscription of the lids is sufficient to record the orientation of the containers and orient the labels according to the inscription on the closure.

The device for rotating the containers can be an orientation star with a pair of friction belts in each bay, the bottle being recorded in each case at opposite points by the friction belt pair. The friction belts can be driven by a stepped motor, which receives its control signals from the control device with the result that the bottles or other containers are rotated in each case by the angle required to reach the target orientation. As mentioned, such an orientation star can be made particularly small for the apparatus according to the invention as pawls, spring-loaded orienting elements or electrooptical close-range scanners are not present for each bay.

The device for rotating the containers can also be integrated into the labelling device. The labelling device has a revolving platform with a plurality of turntables arranged on the periphery on each which resets a container, and also a centering bell placed on the containers from above. To rotate the container during the application of the label the container is rotatably clamped between the turntable and the centering bell. The turntable is usually driven by means of a drag lever, which runs in a curved track. This gives the turntables a preset fixed rotation.

In a variant of the apparatus according to the invention the turntables are driven by stepped motors, the control device being able to steer each turntable such that the desired target orientation for the labelling is reached.

The device for rotating the containers can also be realized by friction belts and a brake device at the edge of the revolving platform, which are controlled by the control device.

The invention also involves a method for applying a label to a container. The method is comprised of the steps of: (a) producing a signal that identifies an orientation of the container; (b) comparing the orientation of the container to a target orientation; (c) generating a signal indicating the relationship of the orientation of the container to the target orientation; (d) realigning the container to the target orientation; and (e) applying the label to the container after the container has been realigned to the target orientation.

### BRIEF DESCRIPTION OF THE DRAWINGS

FIG. 1 is an apparatus for applying labels, including the devices for orienting drinks bottles;

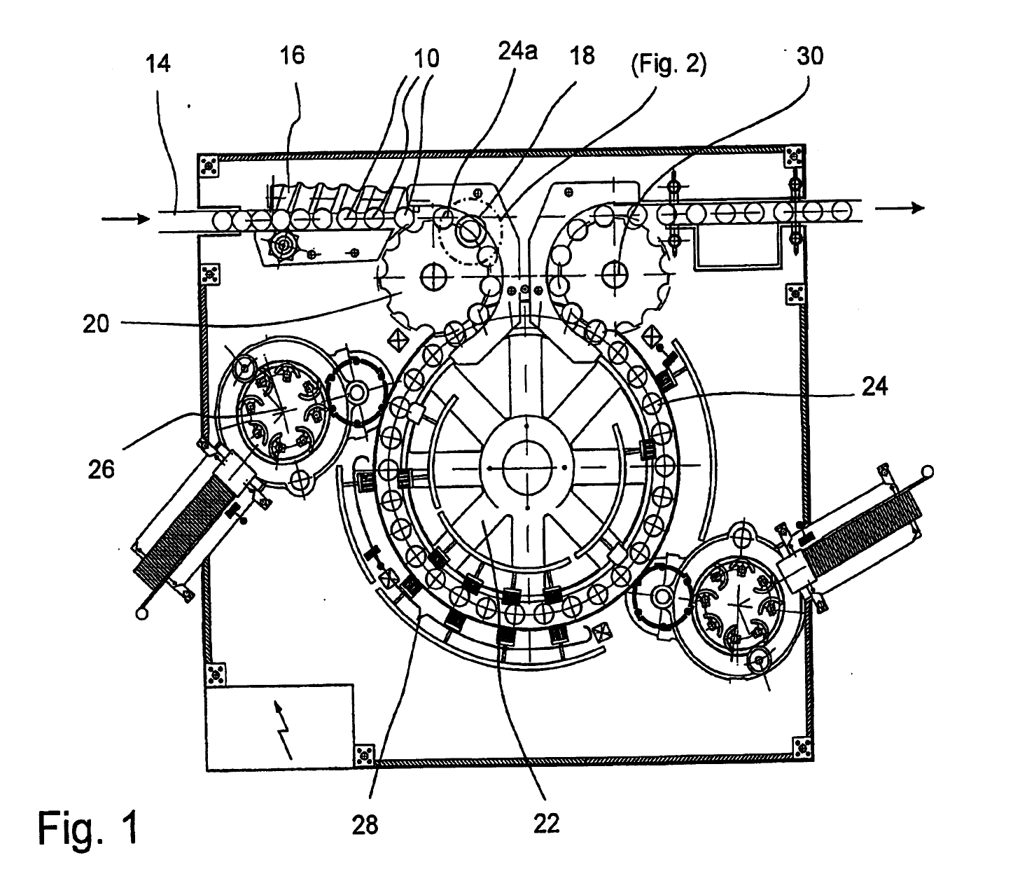

FIG. 2 is the arrangement of CCD camera over the drinks bottle; and

FIG. 3 is a turntable, driven by a stepped motor, of the labelling device.

### DETAILED DESCRIPTION OF THE INVENTION

With the apparatus shown in the drawing, containers in the form of 0.5-litre beer bottles 10, which are sealed with a crown cap closure 12, are conveyed on a conveyor 14 to a spacing worm 16 which arranges the bottles 10 spaced apart at the distance preset by the pitch of the classification worm 16. The bottles 10 are then pushed in customary manner onto a revolving platform 22 by means of an inlet star 20, which has bays for receiving a bottle 10 each.

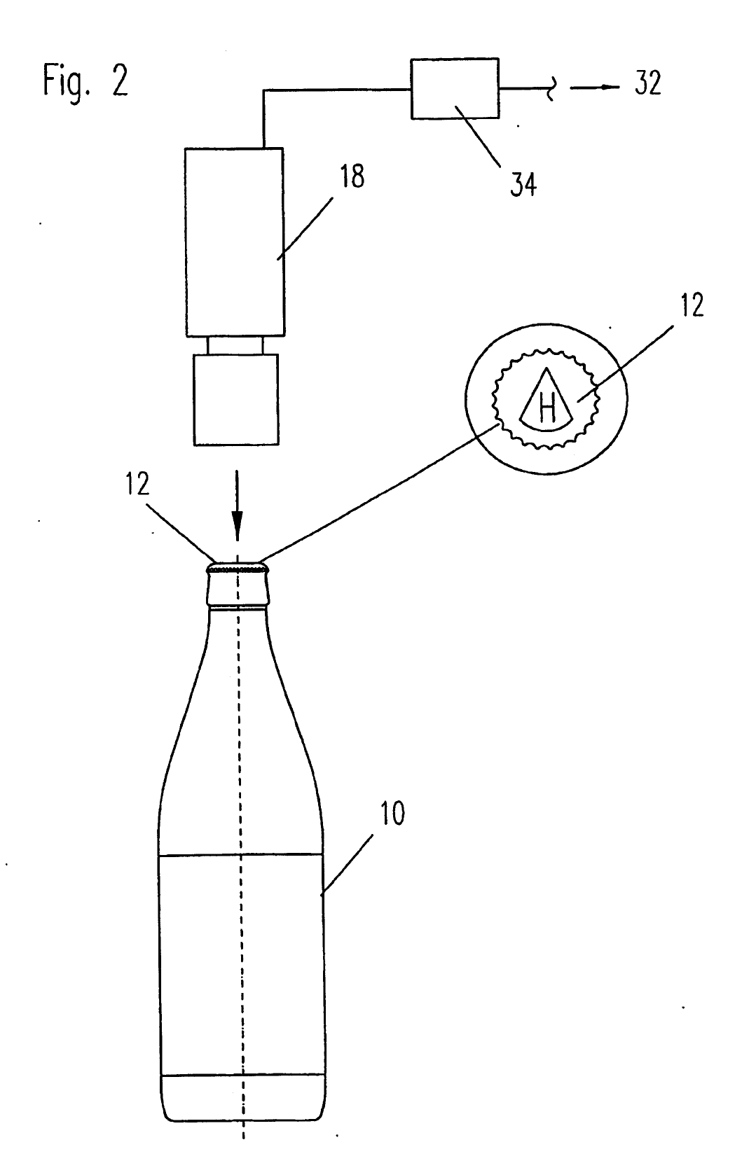

The crown cap closures have on top an inscription (Brewery H-FIG. 2). By means of a CCD camera 18, which is stationary above the inlet star 20, the orientation of the bottles 10, strictly speaking that of the inscription on the crown cap closures is recorded. This is done by processing the image of the crown cap closure 12 taken by the CCD camera 18 using customary image-processing methods.

Rotatably housed turntables are arranged in a manner known per se at the edge of the revolving platform 22. The pitch of the spacing worm, the distance between the bays of the inlet star 20 and the distance between the turntables 24 are matched such that the bottles 10 come to a halt one after the other on the turntables 24 of the rotating revolving platform 22. The bottles 10 are moved on the turntables 24 past a labelling device 26 arranged beside the revolving platform, labels being applied, and these then brushed on within the section 28. The bottles are pushed via an outlet star 30 back onto the conveyor 14 which then conveys them to a packing device.

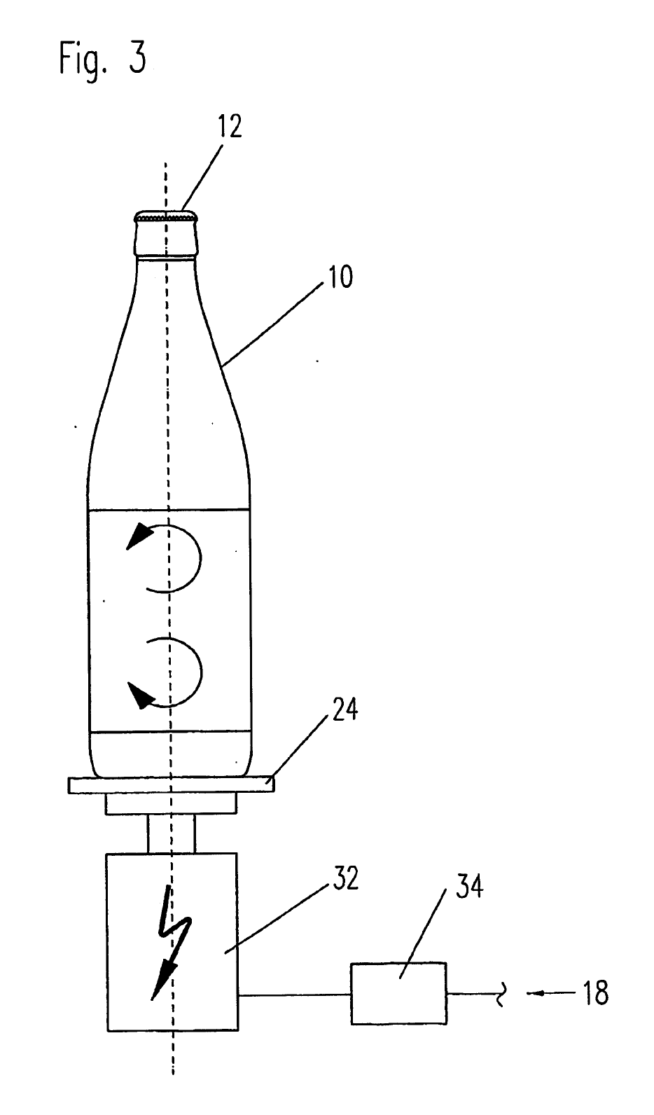

The labelling device 26 corresponds structurally to the state of the art and is therefore not described in more detail. The special feature within the framework of the present invention is that the orientation of the inscription on the crown cap closures 12 is already recorded by the CCD camera 18 before the inlet star 20 or at the latest within the inlet star 20, and that each turntable 24 is equipped with a stepped motor 32 (FIG. 3) which rotates the bottle 10 such that the label is applied in orientation with the inscription on the crown cap closure 12. The stepped motors 32 are controlled by a control device 34 which processes the signals delivered by the CCD camera 18. The revolving platform 22 and the turntables 24 therefore do not need means (cam orientation of electrooptical close-range scanners for champagne orientation etc.) for orienting the bottles.

1-4. (Canceled)

5. An apparatus for applying a label to a container, the apparatus comprised of:
an electrooptical device that is capable of producing a signal which identifies the orientation of the container;
a device for applying the label to the container;
a control device for receiving the signal from the electrooptical device, comparing the orientation of the container to a target orientation and transmitting the relationship of the orientation of the container to the target orientation to a container-orienting device; and
a container-orienting device capable of receiving the identified orientation of the container from the control device and realigning the orientation of the container to a target orientation prior to the application of the label.

6. Apparatus according to claim 5, wherein the container-orienting device is integrated into an inlet star which is arranged in front of the device for applying the labels.

7. Apparatus according to claim 6, wherein the container-orienting device is arranged at one of a position in front of the inlet star and inside the inlet star.

8. Apparatus according to claim 5, wherein the container-orienting device is formed by a number of turntables which are arranged on the periphery of a revolving platform which moves the containers past a labeling device, each turntable being provided with a rotation-drive device which is controlled by the control device.

9. The apparatus according to claim 5, wherein:
the container has a closure that has a surface with an inscription; and
the electrooptical device uses the inscription on the closure to identify the orientation of the container.

10. The apparatus according to claim 5, wherein the container has a longitudinal axis and the control device rotates the container about its longitudinal axis into the target position.

11. The apparatus of claim 5, wherein:
the electrooptical device records the orientation of the container; and
the control device receives the recorded orientation of the container from the electrooptical device.

12. The apparatus of claim 5, wherein:
the device for rotating the container is formed by a plurality of turntables that are arranged on a periphery of a revolving platform that moves the container past a labeling device; and
each of the plurality of turntables is provided with a rotation-drive device that is controlled by the control device.

13. An apparatus for applying a label to a container having a longitudinal axis and a closure having a surface with an inscription directed normally relative to the longitudinal axis., the apparatus comprising:
an electrooptical device for recording the orientation of the containers, said device producing a signal that reproduces the orientation of the container, the orientation of the container being recorded by means of the electrooptical device using the inscription of the closure;
a control device for relating the signal of the electooptical device to a target orientation of the container;
a device for rotating the container about its longitudinal axis into the target orientation, the device for rotating the container being controlled by the control device; and
a device for applying the label after the container has been rotated into the target orientation.

14. The apparatus of claim 13, wherein the device for rotating the container is integrated into an inlet star which is arranged in front of the device for applying the label.

15. The apparatus of claim 13, wherein the device for recording the orientation of the container is arranged in one of a position in front of the inlet star and inside the inlet star.

16. A method for applying a label to a container, the method comprised of the steps of:
producing a signal that identifies an orientation of the container;
comparing the orientation of the container to a target orientation;
generating a signal indicating the relationship of the orientation of the container to the target orientation;
realigning the container to the target orientation; and
applying the label to the container after the container has been realigned to the target orientation.

17. The method of claim 16, wherein an electrooptical device produces the signal identifying the orientation of the container.
